(19) United States
(12) Patent Application Publication
(10) Pub. No.: US 2009/0186782 A1
(43) Pub. Date: Jul. 23, 2009

(54) MIXED DEMULSIFIER OF ASP FLOODING PRODUCED LIQUID

(75) Inventors: Yanming Gao, Beijing (CN); Xingyu Liu, Beijing (CN); Shu-nan Gong, Beijing (CN)

Correspondence Address: SUGHRUE MION, PLLC, 2100 PENNSYLVANIA AVENUE, N.W., SUITE 800, WASHINGTON, DC, 20037, US

(73) Assignees: HIGH GRADE TECHNOLOGY CO., LTD., Beijing (CN); DAQING DAFENG OILFIELD TECHNOLOGY CO., LTD., Daqing City (CN)

(21) Appl. No.: 12/357,925

(22) Filed: Jan. 22, 2009

(30) Foreign Application Priority Data
Jun. 28, 2007 (CN) 200710118094.2

(51) Int. Cl. C09K 8/58

(52) U.S. Cl. 507/220

(57) ABSTRACT

The present invention discloses a mixed demulsifier of ASP flooding production liquid. The demulsifier consists of a functional demulsifier from 70 to 30% by mass and a mixed solvent from 30 to 70% by mass based on the mass of the demulsifier; the functional demulsifier is formed by mixing a polyethylidene polyamine polyoxypropylene polyoxyethylene ether from 35 to 70% by mass and a propanediol polyoxypropylene polyoxyethylene ether from 30 to 65% by mass based on the mass of the functional demulsifier; the mixed solvent comprises one or more of xylene, ethylbenzene, mixed benzene, solvent oil, methanol and isopropanol, or a mixed solution thereof with water. The demulsifier of the present invention has the advantages of high dehydration ratio, quick dehydration speed and flush oil-water interface over the prior art. Upon the demulsification of the production liquid, the oil content of the sewage is less than 200 mg/L and the water content of the oil is less than 8%, so that the effect of oil-water separation of the production liquid is far better than that of the control demulsifier. The demulsifier of the present invention is an excellent mixed demulsifier for treating the ASP flooding production liquid.

### FIELD OF THE INVENTION

The present invention relates to a mixed demulsifier for oil-water separation of ASP (Alkali/Surfactant/Polymer) flooding produced liquid used in an oil production plant in an oilfield.

### BACKGROUND OF THE INVENTION

Some oilfields have implemented ASP flooding. As the oil production time is prolonged, the amount of surfactants, alkalis and polymer withdrawn from the produced liquid is higher and higher, making the oil-water emulsification in the produced liquid worse and worse and the difficulty in demulsifying oil-water emulsion larger and larger. The previously used demulsifiers have been unable to be applied to the case wherein the withdrawn ternary chemicals (ASP) in the production liquid are increased. Upon the demulsification of the production liquid, in the sewage from the free-water dehydrator, the oil content often exceeds the index of 1000 mg/L and in the oil, the water content exceeds the index of 20% (by mass). Because the oil content in the sewage from the free-water dehydrator highly exceeds the index, the oil content of the water after the sewage is treated through a sewage treatment unit also exceeds the index. Also, the oil from the free-water dehydrator has higher water content, resulting in that the stationarity of an electric dehydrator in an electric dehydration process unit becomes poor and the collapse phenomena of the electric field often occurs. The plants for the treatment of the ASP flooding production liquid urgently need a demulsifier applicable for the demulsification of the production liquid with high content of ternary chemicals, which not only makes the treatment of the ASP flooding production liquid qualified, but also makes the oil in the water and the water in the oil after the oil-water separation of the production liquid less, reducing the burden of the sewage treatment unit and the electric dehydration process unit. Currently, there is no demulsifier specially used for the treatment of the ASP flooding production liquid. Most of the used demulsifers are a single type of demulsifiers, such as SP169 demulsifier used in treating the oil containing sewage. These demulsifiers all have a poor effect in treating the ASP flooding production liquid. The mix of two demulsifier with different properties can have a synergic effect, and it is possible not only to make the oil content of the water and the water content of the oil achieve the above indexes but also to make them much lower than the indexes.

### SUMMARY OF THE INVENTION

The technical problem to be solved by the present invention is to overcome the defect that the prior art demulsifiers have a poor effect in treating the ASP flooding production liquid and to provide a mixed demulsifier for the oil-water separation of the ASP flooding production liquid. The use of this demulsifer can achieve the indexes of less than 200 mg/L oil content in the water as well as less than 8% (by mass) water content in the oil after the oil-water separation of the ASP flooding production liquid.

The technical solution of the present invention for solving its technical problem is:

A mixed demulsifier of ASP flooding production liquid, which consists of a functional demulsifier from 70 to 30% by mass and a mixed solvent from 30 to 70% by mass based on the mass of the demulsifier. The functional demulsifier is a mixed liquid of a polyethylidene polyamine polyoxypropylene polyoxyethylene ether from 35 to 70% by mass and a propanediol polyoxypropylene polyoxyethylene ether from 30 to 65% by mass based on the mass of the functional demulsifier. The mixed solvent comprises one or more of xylene, ethylbenzene, mixed benzene, solvent oil, methanol and isopropanol, or a mixed solution of one or more of xylene, ethylbenzene, mixed benzene, solvent oil, methanol and isopropanol with water.

Further, the mixed solvent comprises ethylbenzene, mixed benzene, methanol and isopropanol with ethylbenzene 10-30% by mass, mixed benzene 15-40% by mass, methanol 10-40% by mass, isopropanol 5-20% by mass and water 5-20% by mass.

Further, the mixed solvent comprises xylene, methanol and isopropanol with xylene 10-40% by mass, methanol 10-40% by mass, isopropanol 5-20% by mass and water 5-20% by mass.

In the above functional demulsifier, the polyethylidene polyamine polyoxypropylene polyoxyethylene ether has an average molecule weight of 5000-8000 and a solid content of larger than 65% and the propanediol polyoxypropylene polyoxyethylene ether has an average molecule weight of 3000-5000 and a solid content of larger than 65%.

The demulsifier of the present invention has the advantages of high dehydration ratio, quick dehydration speed and flush oil-water interface over the prior art. Upon the demulsification of the ASP flooding production liquid with the demulsifier of the present invention, the oil content of the sewage is less than 200 mg/L and the water content of the oil is less than 8%, so that the effect of the oil-water separation of the production liquid is far better than that of the control demulsifier, far exceeding the indexes of less than 1000 mg/L oil content in the sewage as well as less than 20% water content in the oil after separating the production liquid. The demulsifier of the present invention is an excellent mixed demulsifier for treating the ASP flooding production liquid.

### DETAILED DESCRIPTION OF THE INVENTION

A process for preparing a mixed demulsifier of ASP flooding production liquid comprises:

Mixing polyethylidene polyamine polyoxypropylene polyoxyethylene ether of 35-70% by mass and propanediol polyoxypropylene polyoxyethylene ether of 30-65% by mass to form the functional demulsifier;

Using one or more of xylene, ethylbenzene, mixed benzene, solvent oil, methanol and isopropanol, or a mixed solution of one or more of xylene, ethylbenzene, mixed benzene, solvent oil, methanol and isopropanol with water as the mixed solvent; and

Uniformly mixing the above formed functional demulsifier of 70-30% by mass with the above used mixed solvent of 30-70% by mass to obtain the product of the present invention.

The mix process of the above demulsifier is carried out in a stirred tank with insulation jacket. The controlled condition is as follows: mixing temperature 20-50° C., stirring rotational rate 30-150 r/min, stirring time 20-50 min and discharging temperature 20-40° C.

When selecting a mixed solvent, one of xylene, ethylbenzene, mixed benzene, solvent oil, methanol and isopropanol can be used; several thereof can also be used as a mixed solvent after mixed; and one or several of xylene, ethylbenzene, mixed benzene, solvent oil, methanol and isopropanol mixed with water can also be used as a mixed solvent. The use of the mixed solvent can make polyethylidene polyamine polyoxypropylene polyoxyethylene ether demulsifier and propanediol polyoxypropylene polyoxyethylene ether demulsifier miscible with each other, and make the demulsifier quickly dispersed in the ASP flooding production liquid. The requirement of constituting the mixed solvent is that the mixed solvent makes the functional demulsifier miscible with each other, the formed demulsifier has a low freezing point, and the mixed solvent is inexpensive.

If a mixed solution of ethylbenzene, mixed benzene, methanol and isopropanol with water is used as the mixed solvent, the mass percent mixing ratio of each solvent is as follows: ethylbenzene 10-30%, mixed benzene 15-40%, methanol 10-40%, isopropanol 5-20% and water 5-20%.

If a mixed solution of xylene, methanol and isopropanol with water is used as the mixed solvent, the mass percent mixing ratio of each solvent is as follows: xylene 10-40%, methanol 10-40%, isopropanol 5-20% and water 5-20%.

The treatment effect of the mixed demulsifier of the present invention on an ASP flooding production liquid having low contents of polymers, surfactants and alkalis remained in the production liquid is as follows. When the ASP flooding production liquid contains polyacrylamide 126 mg/L, surfactants 25 mg/L, alkalis 860 mg/L, pH 9.4, the viscosity of aqueous phase 2.0 mpa·s (45° C.), and the oil content in the water is 1800 mg/L with no demulsifier, the mixed demulsifier for oil-water separation of ASP flooding production liquid produced by this example is applied in the oil-water separation process. When the mixed demulsifier for oil-water separation of ASP flooding production liquid is added in the amount of 20-35 mg/L, the oil content of the water is less than 100 mg/L and the water content of the oil is less than 3% after the oil-water separation of the production liquid.

The treatment effect of the mixed demulsifier of the present invention on an ASP flooding production liquid having high contents of polymers, surfactants and alkalis remained in the production liquid is as follows. The quality of the ASP flooding production liquid is as follows: polyacrylamide 195.8 mg/L; surfactants 49.2 mg/L; alkalis: OH⁻ 311 mg/L, CO₃²⁻ 1248 mg/L, HCO₃⁻ 2421 mg/L; water content 82.2%; pH 9.4; the viscosity of aqueous phase 2.1 mpa·s (45° C.); and the oil content of the water 2166 mg/L with no demulsifier added. When the mixed demulsifier for the oil-water separation of ASP flooding production liquid is added in the amount of 20-35 mg/L, the oil content of the water is less than 150 mg/L and the water content of the oil is less than 5% after the oil-water separation of the production liquid.

The mixed demulsifier for oil-water separation of ASP flooding production liquid is far better than the common demulsifiers, makes both of the oil content of the water and the water content of the oil meet the requirements, and can reduce the oil content of the sewage from 2166 mg/L to less than 150 mg/L.

What is claimed is:

1. A mixed demulsifier of ASP flooding production liquid, characterized in that: the demulsifier consists of a functional demulsifier from 70 to 30% by mass and a mixed solvent from 30 to 70% by mass based on the mass of the demulsifier; the functional demulsifier is a mixed liquid of a polyethylidene polyamine polyoxypropylene polyoxyethylene ether from 35 to 70% by mass and a propanediol polyoxypropylene polyoxyethylene ether from 30 to 65% by mass based on the mass of the functional demulsifier; the mixed solvent comprises one or more of xylene, ethylbenzene, mixed benzene, solvent oil, methanol and isopropanol, or a mixed solution of one or more of xylene, ethylbenzene, mixed benzene, solvent oil, methanol and isopropanol with water.

2. The mixed demulsifier of ASP flooding production liquid of claim 1, characterized in that the mixed solvent comprises ethylbenzene, mixed benzene, methanol and isopropanol with ethylbenzene 10-30% by mass, mixed benzene 15-40% by mass, methanol 10-40% by mass, isopropanol 5-20% by mass and water 5-20% by mass.

3. The mixed demulsifier of ASP flooding production liquid of claim 1, characterized in that the mixed solvent comprises xylene, methanol and isopropanol with xylene 10-40% by mass, methanol 10-40% by mass, isopropanol 5-20% by mass and water 5-20% by mass.

4. The mixed demulsifier of ASP flooding production liquid of claim 1, characterized in that the polyethylidene polyamine polyoxypropylene polyoxyethylene ether has an average molecule weight of 5000-8000 and the propanediol polyoxypropylene polyoxyethylene ether has an average molecule weight of 3000-5000.
